(19) United States
(12) Patent Application Publication
(10) Pub. No.: US 2002/0092748 A1
(43) Pub. Date: Jul. 18, 2002

(54) Safety switch

(76) Inventor: Tsui-Jong Su, Hsin-Tien City (TW)

Correspondence Address: BACON & THOMAS, 4th Floor, 625 Slaters Lane, Alexandria, VA, 22314, US

(21) Appl. No.: 09/761,708

(22) Filed: Jan. 18, 2001

(51) Int. Cl. H01H 21/00

(52) U.S. Cl. 200/339; 200/334

(57) ABSTRACT

An improved safety switch for turning power supply on or off, or switching different specifications of power supply, signals, systems or the like includes a casing, a terminal set located in the casing, a switch element located in the casing, and a press element located at the upper rim of the casing. The press element has a press section which includes two slant planes capable of receiving external force to perform switching or change movement. When the press section is undergoing the switching movement, one of the slant planes will be moved and positioned at about the horizontal level to an opening of the casing formed at the upper rim, and another slant plane will be moved into the casing to form a recess below the upper rim at another opening so that mistaken activation of the switch may be avoided.

### BACKGROUND OF THE INVENTION

This invention relates to a safety switch and particularly a safety switch that is capable of preventing users or people from mistakenly activating the switch.

There are a wide variety of switches being used in all sorts of instruments and electric household appliances. Most of the switches have different function or serve different purposes. For instance, some of them are used to turn power on or off for the instruments or appliances, some others are for switching different specifications of power supply or signals or systems for users to use different types of instruments or appliances.

It is not unusual that users might incidentally mishandle or mistakenly activate the switch. This is especially true for the switches which have the press element exposed outside. When such an event happens, the instruments or appliances will be turned on or off unintentionally, or switched to a different specification or system in a not proper way. It could cause serious consequences such as damage the instruments or appliances, or even result in safety hazard to people.

### SUMMARY OF THE INVENTION

In view of aforesaid disadvantages, it is therefore an object of this invention to provide a safety switch for preventing people from mistakenly activate the switch.

Another object of this invention is to provide a switch that may be used for turning power supply on or off, or for switching different specifications of power supply, signals, systems, or the like.

A further object of this invention is to protect the instruments or appliances from undue damage and to increase their durability.

In order to achieve aforesaid objects, the safety switch according to this invention includes a casing, a terminal set located in the casing, a switch element located in the casing, and a press element located at an upper rim of the casing and above the switch element. The press element has a press section which includes two slant planes capable of receiving external force to perform switching or change movement. When the press section is undergoing the switching movement, one of the slant planes will be moved and positioned horizontally at about an opening of the casing formed at the upper rim, and another slant plane will be moved into the casing to form a recess below the upper rim at another opening so that mistaken activation of the switch may be avoided.

### BRIEF DESCRIPTION OF THE DRAWINGS

The invention, as well as its many advantages, may be further understood by the following detailed description and drawings, in which:

FIG. 1 is an exploded view of this invention.

FIG. 2 is a sectional view of this invention.

FIG. 3 is another sectional view of this invention in use.

FIG. 4 is a sectional view of another embodiment of this invention.

FIG. 5 is a sectional view of yet another embodiment of this invention.

### DESCRIPTION OF THE PREFERRED EMBODIMENTS

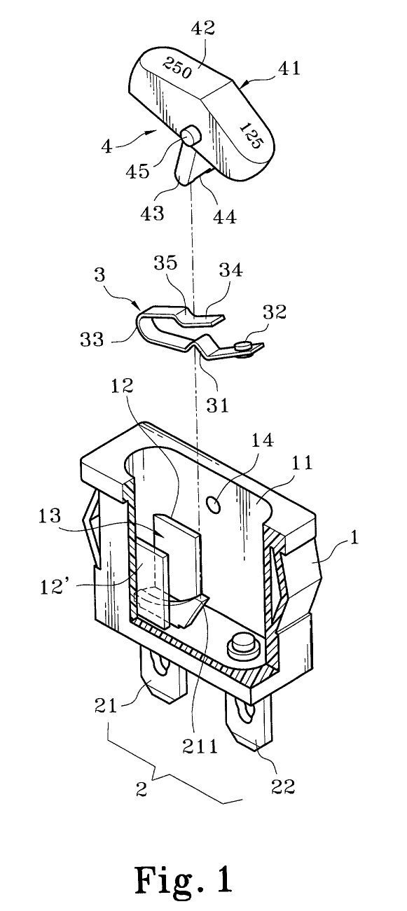

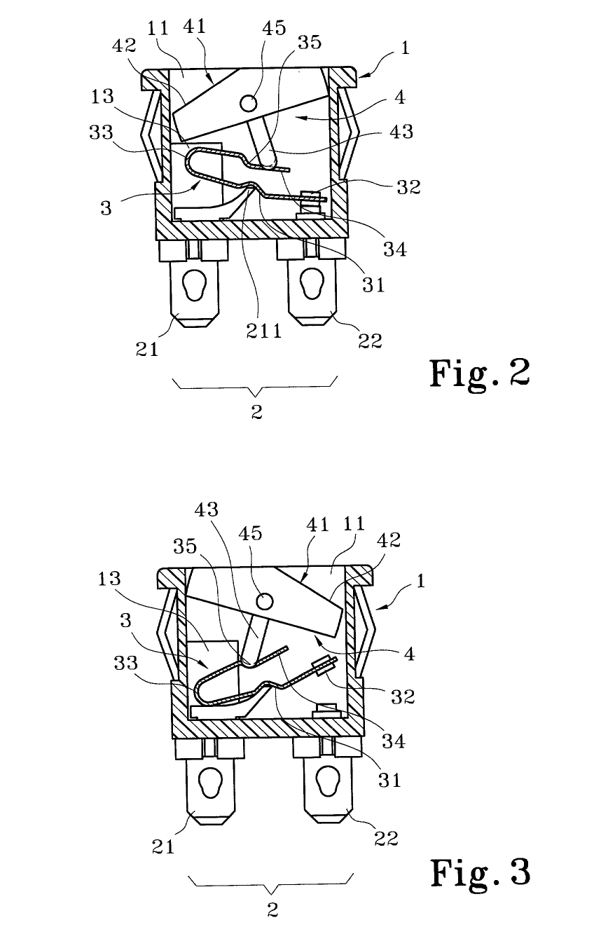

Referring to FIGS. 1 and 2, the safety switch according to this invention includes a casing 1, a terminal set 2 located in the casing, a switch element 3 located in the casing 1, and a press element 4 located at the upper rim of the casing 1 and above the switch element 3.

The casing 1 has a cavity 11 in which there are two spaced slates 12 and 12′ extended upward from the bottom wall thereof and a pivot zone 14 located at an upper section close to a top opening formed at the upper rim thereof. The space between the two slates 12 and 12′ becomes an activate zone 13.

The terminal set 2 includes, but not limit to, two terminals 21 and 22 extended downward from the bottom wall of the casing 1. The terminal 21 has one end extended into the activate zone 13 and formed an anchor point 21 1.

The switch element 3 is formed by, but not limit to, a metal strip in substantially a transverse U-shaped manner, and has a lower lever which has a concave notch 31 formed in a middle portion thereof pivotally resting on the anchor point 211 and a free end formed a contact 32 for contacting with another terminal 22. The switch element 3 has a bent section 33 and an upper lever beyond the bent section 33. The upper lever has slant section 35 formed at about the middle portion thereof and a compression section 34 formed at a free end thereof.

The press element 4 has a press section 41 which includes two slant planes 42 each may be printed or embossed with a selected remark (such as different voltage specification number, signal, system, or the like) for users recognition and selection. The press element 4 further has a trigger finger 43 mounted below the press section 41. The trigger finger 43 has a notch 44 formed at the bottom end thereof for straddling over the slant section 35. The press section 41 further has two pivotal shafts 45 engaged with the pivot zone 41.

Referring to FIGS. 2 and 3, when the press element 41 does not receive an external pressing force and the notch 44 (FIG. 1) of the trigger finger 43 is located outside the slant section 35, the contact 32 contacts the terminal 22 and forms an electric conductive state.

When another end of the press section 41 receives an external pressing force, the notch 44 will slip to the slant section 35 and makes the contact 32 moving away from the terminal 22 and cutting off the electric connection. Hence this switch motion may be used to switch different specifications of voltage (or signals, systems or the like), or for turning on or off power supply.

When the press element 41 receives an external force and makes switch movement, one end of the plane 42 is moved upward to the opening formed at the upper rim of the casing 1 and may be positioned horizontally at the upper rim level or slightly lower than the upper rim level, while another end of the plane 42 will be moved downward into the casing 1 to form a recess from the upper rim. As the press section 41 is not exposed outside the casing 1, it greatly reduces the possibility of accidentally or wrongly activated by people.

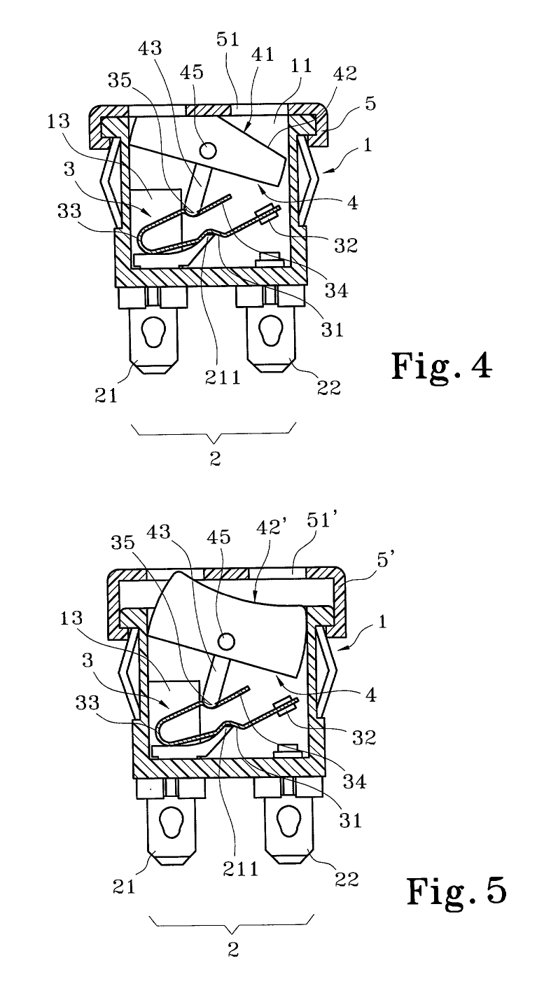

FIG. 4 shows another embodiment of this invention. It is largely constructed like the one shown in FIG. 2. However the casing 1 is covered by a cap 5 which has two openings 51 mating against two planes of the press section 41 of the press element 4 for further enhancing the safety of the switch. Of course, the press section 41 may also printed or embossed with remarks to indicate switch selections. As the press section 41 is located inside the cap 5, users have to use a pointed object to press the press element 4 for activating the switch function.

FIG. 5 illustrates yet another embodiment of this invention. It is largely constructed like the one shown in FIG. 4. However, the press section 41 is formed in a concave curve surface 42′. When making switch operation, one end of the curved surface will be moved above the upper rim of the casing 1. Hence the cap 5′ is made with a deeper space inside to fully cover the press section 41 of the press element 4. The cap 5′ also has openings 51′ which enable users to press the press element 4 by means of a pointed object for making switch desired or turning power on or off.

What is claimed is:

1. A safety switch, comprising:
a casing having an opening formed at an upper rim thereof;
a terminal set located in the casing;
a switch element located in casing; and
a press element located at the upper rim of the casing and above the switch element, having a press section which has two slant planes;
wherein when the press section receives an external pressing force to perform switch function, one slant plane is moved substantially to the opening at the upper rim at a horizontal position, and another slant plane is moved into the casing for forming a recess from the opening for preventing the press section from wrongly activating.

2. The safety switch of claim 1, wherein the slant planes have remarks printed or embossed thereon for indicating different switch specifications including voltage, signals, systems, or power on and off.

3. The safety switch of claim 1 further having a cap covered the upper rim of the casing, the cap having two openings located respectively above the slant planes.

4. The safety switch of claim 1, wherein the press section has a curved press surface, the casing having a cap covered the upper rim thereof, the cap having an opening formed therein.
